(19) United States
(12) Patent Application Publication
(10) Pub. No.: US 2020/0225051 A1
(43) Pub. Date: Jul. 16, 2020

(54) SYSTEM AND METHOD TO DETERMINE A TRAVEL PATH BASED ON AIR QUALITY

(71) Applicant: GM GLOBAL TECHNOLOGY OPERATIONS LLC, Detroit, MI (US)

(72) Inventors: Ravikiran Dhullipala Chenchu, Canton, MI (US); Anil Kumar Nichenametla, Canton, MI (US); Amar Badal, Rochester Hills, MI (US); Anthony J. Sumcad, Troy, MI (US)

(21) Appl. No.: 16/248,904

(22) Filed: Jan. 16, 2019

(51) Int. Cl. G01C 21/34; G05D 1/02

(52) U.S. Cl. CPC G01C 21/3453; G05D 1/021

(57) ABSTRACT

One general aspect includes a method of calculating an ideal travel route based on air quality, the method including: receiving, at a processor, a vehicle location; receiving, at the processor, a destination; identifying, via the processor, a plurality of travel segments based on the vehicle location and destination; receiving, via the processor, one or more air quality index (AQI) markers associated with each travel segment; and calculating, via the processor, the ideal travel route based on the one or more AQI markers associated with each travel segment.

### INTRODUCTION

An air quality index (AQI) is a number used by government agencies, such as, for example, the United States Environmental Protection Agency (EPA), to communicate to the public how polluted the air currently is at a given location. Computation of the AQI requires an air pollutant concentration over a specified averaging time period, obtained from an air monitor or model. Taken together, concentration and time represent the dose of the pollutant (e.g., pollen, factory emissions, chemical fertilizations, etc.). The AQI of a given area can also increase due to an increase of pollution (for example, during rush hour traffic or when there is an upwind forest fire) or from a lack of dilution of the pollutants. That said, as the AQI increases, an increasingly sizable percentage of the population is likely to experience increasingly severe adverse health effects. Based on EPA guidelines, an AQI of 0-50 can represent a low health risk category (i.e., good air quality) and an ideal air quality for outdoor activities. Conversely, an AQI of 151-200 can represent a high health risk category (i.e., unhealthy air quality) and that the general population should consider reducing strenuous outdoor activities. Moreover, AQI can vary drastically from town to town or neighborhood to neighborhood along a driving route. Thus, the average AQI one experiences along their commute can vary drastically depending on the path they choose to travel from point “A” to point “B”. As follows, enabling people to take precautions and travel according to their personal air sensitivity can allow them to have a more pleasant trip as well as one that is suited to their health needs. It is therefore desirable to provide a system and method that allows a user to commute from one point to another based on the air quality therebetween. It is also desirable for this system and method to choose a specific travel route between these points based on the user's air quality preferences. Moreover, other desirable features and characteristics of the present invention will become apparent from the subsequent detailed description of the invention and the appended claims, taken in conjunction with the accompanying drawings and this background of the invention.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method of calculating an ideal travel route based on air quality, the method including: receiving, at a processor, a vehicle location; receiving, at the processor, a destination; identifying, via the processor, a plurality of travel segments based on the vehicle location and destination; receiving, via the processor, one or more air quality index (AQI) markers associated with each travel segment; and calculating, via the processor, the ideal travel route based on the one or more AQI markers associated with each travel segment. Other embodiments of this aspect include corresponding computer systems, apparatus, and computer programs recorded on one or more computer storage devices, each configured to perform the actions of the methods.

Implementations may include one or more of the following features. The method further including: where the vehicle is an autonomous vehicle; generating, via the processor, one or more executable instructions configured to cause the vehicle to autonomously travel from the vehicle location to the destination along the ideal travel route; and transmitting, via the processor, the one or more executable instructions to the vehicle. The method further including: receiving, at the vehicle, the one or more executable instructions; and executing, via the vehicle, the executable instructions so as to autonomously travel from the vehicle location to the destination along the ideal travel route. The method further including: producing, via the processor, one or more executable instructions configured to generate a user interface to prompt a user to operate the vehicle to travel from the vehicle location to the destination along the ideal travel route, where the user interface can be displayed on a display of the vehicle; and transmitting, via the processor, the one or more executable instructions to the vehicle. The method further including: receiving, via the processor, an air quality preference from the vehicle; and where the ideal travel route is additionally based on the air quality preference. The method where the one or more AQI markers are retrieved from an AQI module remotely located in a computer. The method where the one or more AQI markers are based on air quality data provided from numerous vehicles in wireless communication with the processor. Implementations of the described techniques may include hardware, a method or process, or computer software on a computer-accessible medium.

One general aspect includes a system to calculate an ideal travel route based on air quality, the system including: a memory configured to include one or more executable instructions and a processor configured to execute the executable instructions, where the executable instructions enable the processor to carry out the following steps: receiving a vehicle location from a vehicle; receiving a destination from the vehicle; identifying a plurality of travel segments based on the vehicle location and destination; receiving one or more air quality index (AQI) markers associated with each travel segment; and calculating the ideal travel route based on the one or more AQI markers associated with each travel segment. Other embodiments of this aspect include corresponding computer systems, apparatus, and computer programs recorded on one or more computer storage devices, each configured to perform the actions of the methods.

Implementations may include one or more of the following features. The system further including: where the vehicle is an autonomous vehicle; the executable instructions enable the processor to carryout the following steps: generating one or more software instructions configured to cause the vehicle to autonomously travel from the vehicle location to the destination along the ideal travel route; and transmitting the one or more software instructions to the vehicle. The system further including: receiving, at the vehicle, the one or more software instructions; and executing, via the vehicle, the software instructions so as to autonomously travel from the vehicle location to the destination along the ideal travel route. The system further including: producing one or more software instructions configured to generate a user interface to prompt a user to operate the vehicle to travel from the vehicle location to the destination along the ideal travel route, where the user interface can be displayed on a display of the vehicle; and transmitting the one or more software instructions to the vehicle. The system further including: where the executable instructions enable the processor to carryout the step of receiving an air quality preference from the vehicle; and where the ideal travel route is additionally based on the air quality preference. The system where the one or more AQI markers are retrieved from an AQI module remotely located in a computer. The system where the one or more AQI markers are based on air quality data provided from numerous vehicles in wireless communication with the processor. Implementations of the described techniques may include hardware, a method or process, or computer software on a computer-accessible medium.

One general aspect includes a non-transitory and machine-readable medium having stored thereon executable instructions adapted to calculate an ideal travel route based on air quality, which when provided to a processor and executed thereby, causes the processor to carry out the following steps: receiving a vehicle location from a vehicle; receiving a destination from the vehicle; identifying a plurality of travel segments based on the vehicle location and destination; receiving one or more air quality index (AQI) markers associated with each travel segment; and calculating the ideal travel route based on the one or more AQI markers associated with each travel segment. Other embodiments of this aspect include corresponding computer systems, apparatus, and computer programs recorded on one or more computer storage devices, each configured to perform the actions of the methods.

Implementations may include one or more of the following features. The non-transitory and machine-readable memory further including: where the vehicle is an autonomous vehicle; the executable instructions enable the processor to carryout the following steps: generating one or more software instructions configured to cause the vehicle to autonomously travel from the vehicle location to the destination along the ideal travel route; and transmitting the one or more software instructions to the vehicle. The non-transitory and machine-readable memory further including: receiving, at the vehicle, the one or more software instructions; and executing, via the vehicle, the software instructions so as to autonomously travel from the vehicle location to the destination along the ideal travel route. The non-transitory and machine-readable memory further including: producing one or more software instructions configured to generate a user interface to prompt a user to operate the vehicle to travel from the vehicle location to the destination along the ideal travel route, where the user interface can be displayed on a display of the vehicle; and transmitting, via the processor, the one or more executable instructions to the vehicle. The non-transitory and machine-readable memory further including: where the executable instructions enable the processor to carryout the step of receiving an air quality preference from the vehicle; and where the ideal travel route is additionally based on the air quality preference. The non-transitory and machine-readable memory where the one or more AQI markers are retrieved from an AQI module remotely located in a computer. Implementations of the described techniques may include hardware, a method or process, or computer software on a computer-accessible medium.

The above features and advantages and other features and advantages of the present teachings are readily apparent from the following detailed description for carrying out the teachings when taken in connection with the accompanying drawings.

### BRIEF DESCRIPTION OF THE DRAWINGS

The disclosed examples will hereinafter be described in conjunction with the following drawing figures, wherein like numerals denote like elements, and wherein:

FIG. 1 is a block diagram depicting an exemplary embodiment of a communications system capable of utilizing the system and method disclosed herein;

FIG. 2 is a schematic diagram of an autonomously controlled vehicle, according to an embodiment of the communications system of FIG. 1;

FIG. 3 is a schematic block diagram of an exemplary automated driving system (ADS) for the vehicle of FIG. 2;

FIG. 4 is an exemplary flow chart for utilization of system and method aspects disclosed herein;

FIG. 5 is an illustrative aspect of the process flow of FIG. 4; and

FIG. 6 is another illustrative aspect of the process flow of FIG. 4.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present system and/or method. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The following detailed description is merely exemplary in nature and is not intended to limit the application and uses. Furthermore, there is no intention to be bound by any expressed or implied theory presented in the preceding background and brief summary or the following detailed description. As used herein, the term module refers to an application specific integrated circuit (ASIC), an electronic circuit, a processor (shared, dedicated, or group) and memory that executes one or more software or firmware programs or code segments, a combinational logic circuit, and/or other suitable components that provide the described functionality.

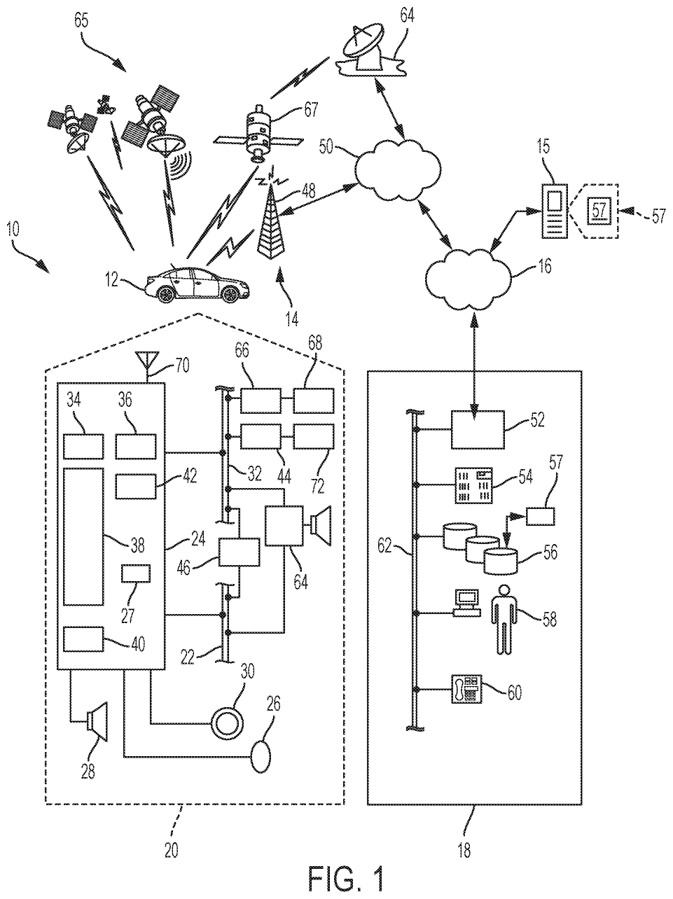

As shown in FIG. 1, there is shown a non-limiting example of a communication system 10 that may be used together with examples of the system disclosed herein and/or to implement examples of the methods disclosed herein. Communication system 10 generally includes a fleet of vehicles 12, a wireless carrier system 14, a land network 16, and a data center 18 (i.e., the backend). It should be appreciated that the overall architecture, setup, and operation, as well as the individual components of the illustrated system are merely exemplary and that differently configured communication systems may also be utilized to implement the examples of the system and/or method disclosed herein. Thus, the following paragraphs, which provide a brief overview of the illustrated communication system 10, are not intended to be limiting.

Each fleet vehicle 12 may be any type of autonomous vehicle (discussed below) such as a motorcycle, car, truck, bicycle, recreational vehicle (RV), boat, plane, etc., and is equipped with suitable hardware and software that enables it to communicate over communication system 10. In certain embodiments, each vehicle 12 may include a power train system with multiple generally known torque-generating devices including, for example, one or more electric motors or traction motors that convert electrical energy into mechanical energy for vehicle propulsion.

Some of the fundamental vehicle hardware 20 for each fleet vehicle is shown generally in FIG. 1 including a telematics unit 24, a microphone 26, speaker 28, and buttons and/or controls 30 connected to telematics unit 24. Operatively coupled to telematics unit 24 is a network connection or vehicle bus 32. Examples of suitable network connections include a controller area network (CAN), a media oriented system transfer (MOST), a local interconnection network (LIN), an Ethernet, dedicated short-range communications channel (DSRC), and other appropriate connections such as those that conform with known ISO (International Organization for Standardization), SAE (Society of Automotive Engineers), and/or IEEE (Institute of Electrical and Electronics Engineers) standards and specifications, to name a few.

The telematics unit 24 is a communication system which provides a variety of services through its communications with the data center 18, and generally includes an electronic processing device 38, one or more types of electronic memory 40, a cellular chipset/component 34, wireless modem 36, dual mode antenna 70, and navigation unit containing a GPS chipset/component 42 capable of communicating location information via a GPS satellite system 65. GPS component 42 thus receives coordinate signals from a constellation of GPS satellites 65. From these signals, the GPS component 42 can determine vehicle position, which may be used for providing navigation and other position-related services to the vehicle operator. Navigation information can be presented on a display of telematics unit 24 (or other display within the vehicle) or can be presented verbally such as is done when supplying turn-by-turn navigation. The navigation services can be provided using a dedicated in-vehicle navigation module (which can be part of GPS component 42), or some or all navigation services can be done via telematics unit 24, wherein the location coordinate information is sent to a remote location for purposes of providing the vehicle with navigation maps, map annotations, route calculations, and the like.

The telematics unit 24 may provide various services including: turn-by-turn directions and other navigation-related services provided in conjunction with the GPS component 42; airbag deployment notification and other emergency or roadside assistance-related services provided in connection with various crash and/or collision sensor interface modules 66 and collision sensors 68 located throughout the vehicle and/or infotainment-related services where music, interne web pages, movies, television programs, videogames, and/or other content are downloaded by an infotainment center 46 operatively connected to the telematics unit 24 via vehicle bus 32 and audio bus 22. In one example, downloaded content is stored for current or later playback. The above-listed services are by no means an exhaustive list of all the capabilities of telematics unit 24, but are simply an illustration of some of the services telematics unit 24 may be capable of offering. It is anticipated that telematics unit 24 may include a number of additional components in addition to and/or different components from those listed above.

Vehicle communications may use radio transmissions to establish a voice channel with wireless carrier system 14 so that both voice and data transmissions can be sent and received over the voice channel. Vehicle communications are enabled via the cellular component 34 for voice communications and the wireless modem 36 for data transmission. Any suitable encoding or modulation technique may be used with the present examples, including digital transmission technologies, such as TDMA (time division multiple access), CDMA (code division multiple access), W-CDMA (wideband CDMA), FDMA (frequency division multiple access), OFDMA (orthogonal frequency division multiple access), etc. To accomplish this effect, dual mode antenna 70 services the GPS component 42 and the cellular component 34.

Microphone 26 provides the driver or other vehicle occupant with a means for inputting verbal or other auditory commands, and can be equipped with an embedded voice processing unit utilizing a human/machine interface (HMI) technology known in the art. Conversely, speaker 28 provides audible output to the vehicle occupants and can be either a stand-alone speaker specifically dedicated for use with the telematics unit 24 or can be part of a vehicle audio component 64. In either event, microphone 26 and speaker 28 enable vehicle hardware 20 and data center 18 to communicate with the occupants through audible speech. The vehicle hardware also includes one or more buttons and/or controls 30 for enabling a vehicle occupant to activate or engage one or more of the vehicle hardware components 20. For example, one of the buttons and/or controls 30 can be an electronic pushbutton used to initiate voice communication with data center 18 (whether it be a human such as advisor 58 or an automated call response system). In another example, one of the buttons and/or controls 30 can be used to initiate emergency services.

The audio component 64 is operatively connected to the vehicle bus 32 and the audio bus 22. The audio component 64 receives analog information, rendering it as sound, via the audio bus 22. Digital information is received via the vehicle bus 32. The audio component 64 provides amplitude modulated (AM) and frequency modulated (FM) radio, compact disc (CD), digital video disc (DVD), and multimedia functionality independent of the infotainment center 46. Audio component 64 may contain a speaker system, or may utilize speaker 28 via arbitration on vehicle bus 32 and/or audio bus 22.

The vehicle crash and/or collision detection sensor interface 66 is operatively connected to the vehicle bus 32. The collision sensors 68 provide information to telematics unit 24 via the crash and/or collision detection sensor interface 66 regarding the severity of a vehicle collision, such as the angle of impact and the amount of force sustained.

Vehicle sensors 72, connected to various vehicle sensor modules 44 (VSMs) in the form of electronic hardware components located throughout each fleet vehicle and use the sensed input to perform diagnostic, monitoring, control, reporting and/or other functions. Each of the VSMs 44 is preferably connected by vehicle bus 32 to the other VSMs, as well as to the telematics unit 24, and can be programmed to run vehicle system and subsystem diagnostic tests. As examples, one VSM 44 can be an engine control module (ECM) that controls various aspects of engine operation such as fuel ignition and ignition timing. According to one embodiment, the ECM is equipped with on-board diagnostic (OBD) features that provide myriad real-time data, such as that received from various sensors including vehicle emissions sensors, fuel diagnostics sensors, and vehicle oil pressure sensors as well as provide a standardized series of diagnostic trouble codes (DTCs) which allow a technician to rapidly identify and remedy malfunctions within the vehicle. VSM 44 can similarly be a powertrain control module (PCM) that regulates operation of one or more components of the powertrain system. Another VSM 44 can be a body control module (BCM) that monitors and governs various electrical components located throughout the vehicle body like the vehicle's power door locks, air conditioner, tire pressure, lighting system, engine ignition, vehicle seat adjustment and heating, mirrors, and headlights. Furthermore, as can be appreciated by skilled artisans, the above-mentioned VSMs are only examples of some of the modules that may be used the vehicles 12, as numerous others are also possible.

Wireless carrier system 14 may be a cellular telephone system or any other suitable wireless system that transmits signals between the vehicle hardware 20 and land network 16. According to an example, wireless carrier system 14 includes one or more cell towers 48.

Land network 16 can be a conventional land-based telecommunications network connected to one or more landline telephones, and that connects wireless carrier system 14 to data center 18. For example, land network 16 can include a public switched telephone network (PSTN) and/or an Internet protocol (IP) network, as is appreciated by those skilled in the art. Of course, one or more segments of the land network 16 can be implemented in the form of a standard wired network, a fiber or other optical network, a cable network, other wireless networks such as wireless local networks (WLANs) or networks providing broadband wireless access (BWA), or any combination thereof.

Data center 18 is designed to provide the vehicle hardware 20 with a number of different system backend functions and, according to the example shown here, generally includes one or more switches 52, servers 54, databases 56, advisors 58 as well as a variety of other telecommunication/computer equipment 60. These various data center components are suitably coupled to one another via a network connection or bus 62, such as the one previously described in connection with the vehicle hardware 20. Switch 52, which can be a private branch exchange (PBX) switch, routes incoming signals so that voice transmissions are usually sent to either advisor 58 or an automated response system, and data transmissions are passed on to a modem or other piece of telecommunication/computer equipment 60 for demodulation and further signal processing. The modem or other telecommunication/computer equipment 60 may include an encoder, as previously explained, and can be connected to various devices such as a server 54 and database 56. Although the illustrated example has been described as it would be used in conjunction with a manned data center 18, it will be appreciated that the data center 18 can be any central or remote facility, manned or unmanned, mobile, or fixed, to or from which it is desirable to exchange voice and data.

Server 54 can incorporate a data controller which essentially controls its operations. Server 54 may control data information as well as act as a transceiver to send and/or receive the data information (i.e., data transmissions) stored on one or more of the databases 56 and/or telematics unit 24. The controller is moreover capable of reading executable instructions stored in a non-transitory machine readable medium and may include one or more from among a processor, microprocessor, central processing unit (CPU), graphics processor, Application Specific Integrated Circuits (ASICs), Field-Programmable Gate Arrays (FPGAs), state machines, and a combination of hardware, software, and firmware components. An example of the data information that may be stored on databases 56 can be air quality information provided from numerous vehicles in communication with data center 18. As such, each of these connected vehicles may include an air quality sensor 72 that can read the air quality in the vehicle's surrounding environment. Thus, as each of these vehicles travel from one point to another, the vehicles will transmit air quality data along with their vehicle location to server 54 and the server 54 will subsequently implement known crowdsourcing techniques to generate numerous real-time air quality markers that can be configured to be populated onto a virtual map.

Computer 15 can be one of a number of computers accessible via a private or public network such as the Internet. Each such computer 15 can be used for one or more purposes, such as a web server accessible by the vehicle via wireless carrier 14. Other such accessible computers 15 can be, for example: a service center computer (e.g., a SIP Presence server) where diagnostic information and other vehicle data can be uploaded from the vehicle via the telematics unit 24; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with vehicle 12 or data center 18. Computer 15 can also be used for providing Internet connectivity such as DNS services or as a network address server that uses DHCP or other suitable protocol to assign an IP address to the vehicle 12.

Computer 15 could be designed to store numerous application program interface (API) suites. Moreover, in certain instances, these API suites may be accessible to the system user, data center 18, or one or more third parties. As an example, one API suite can be an Air Quality Index (AQI) module 57 managed by the Environmental Protection Agency of the United States (EPA) (see www.airnow.gov). Thus, the AQI module 57 generates map data using federal reference or equivalent monitoring techniques or techniques approved by the state, local, or tribal monitoring agencies. In addition to the map data, AQI module 57 can produce AQI markers configured to be positioned at various points along the virtual map such as, for example, along a path of travel (e.g., along a road and highway). Moreover, AQI module 57 can export the AQI markers to one or more third party virtual maps so as to be populated onto the third party's virtual map. It should be understood that the AQI markers represent the categorized AQI quality and AQI number at a specific location.

Autonomous Vehicle Aspects

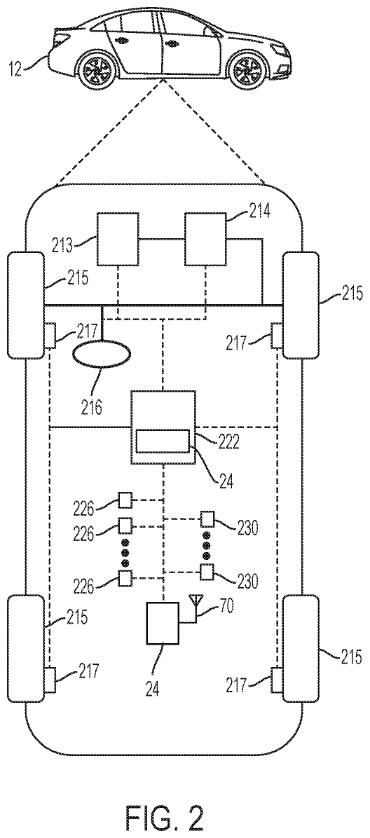

With reference to FIG. 2, each fleet vehicle 12 can be an autonomous vehicle (AV) that generally includes a transmission 214 which may be installed to transmit power from propulsion system 213 to vehicle wheels 215 according to selectable speed ratios. According to various embodiments, transmission 214 may include a step-ratio automatic transmission, a continuously-variable transmission, or other appropriate transmission. Fleet vehicle 12 additionally includes wheel brakes 217 configured to provide braking torque to the vehicle wheels 215. The wheel brakes 217 may, in various embodiments, include friction brakes, a regenerative braking system such as an electric machine, and/or other appropriate braking systems. It should be understood transmission 214 does not necessarily need to be installed for propulsion system 213 to propel fleet vehicle 12.

Each fleet vehicle 12 additionally includes a steering system 216. While depicted as including a steering wheel for illustrative purposes, in some contemplated embodiments, the steering system 216 may not include a steering wheel. Telematics unit 24 is additionally configured to wirelessly communicate with other vehicles (“V2V”) and/or infrastructure (“V2I”) and/or pedestrians (“V2P”). These communications may collectively be referred to as a vehicle-to-entity communication (“V2X”). In an exemplary embodiment, this communication system communicates via at least one dedicated short-range communications (DSRC) channel. DSRC channels refer to one-way or two-way short-range to medium-range wireless communication channels specifically designed for automotive use and a corresponding set of protocols and standards.

The propulsion system 213 (explained above), transmission 214, steering system 216, and wheel brakes 217 are in communication with or under controls device 222. Vehicle controls device 222 includes an automated driving system (ADS) 224 for automatically controlling various actuators in the vehicle. In an exemplary embodiment, ADS 224 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. In an exemplary embodiment, the ADS 224 is configured to communicate automated driving information with and control propulsion system 213, transmission 214, motors 219, steering system 216, and wheel brakes 217 to control vehicle acceleration, steering, and braking, respectively, without human intervention via a plurality of actuators 230 in response to inputs from a plurality of driving sensors 226, which may include GPS, RADAR, LIDAR, optical cameras, thermal cameras, ultrasonic sensors, and/or additional sensors as appropriate.

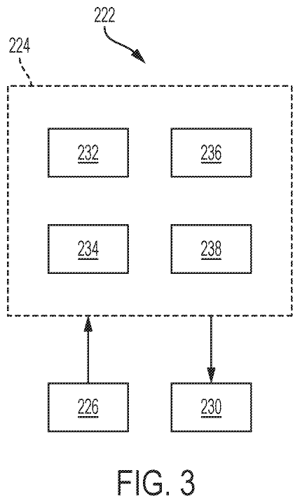

In various embodiments, the instructions of the ADS 224 may be organized by function or system. For example, as shown in FIG. 3, ADS 224 can include a sensor fusion system 232 (computer vision system), a positioning system 234, a guidance system 236, and a vehicle control system 238. As can be appreciated, in various embodiments, the instructions may be organized into any number of systems (e.g., combined, further partitioned, etc.) as the disclosure is not limited to the present examples.

In various embodiments, the sensor fusion system 232 synthesizes and processes sensor data and predicts the presence, location, classification, and/or path of objects and features of the environment of the vehicle 12. In various embodiments, the sensor fusion system 232 can incorporate information from multiple sensors, including but not limited to cameras, lidars, radars, and/or any number of other types of sensors. In one or more exemplary embodiments described herein, the sensor fusion system 232 supports or otherwise performs the ground reference determination processes and correlates image data to lidar point cloud data, the vehicle reference frame, or some other reference coordinate frame using calibrated conversion parameter values associated with the pairing of the respective camera and reference frame to relate lidar points to pixel locations, assign depths to the image data, identify objects in one or more of the image data and the lidar data, or otherwise synthesize associated image data and lidar data. In other words, the sensor output from the sensor fusion system 232 provided to the vehicle control system 238 (e.g., indicia of detected objects and/or their locations relative to the vehicle 12) reflects or is otherwise influenced by the calibrations and associations between camera images, lidar point cloud data, and the like.

The positioning system 234 processes sensor data along with other data to determine a position (e.g., a local position relative to a map, an exact position relative to lane of a road, vehicle heading, velocity, etc.) of the vehicle 12 relative to the environment. The guidance system 236 processes sensor data along with other data to determine a path for the vehicle 12 to follow (i.e., path planning data). The vehicle control system 238 generates control signals for controlling the vehicle 12 according to the determined path.

Controls device 222 may include a microprocessor such as a central processing unit (CPU) or graphics processing unit (GPU) in communication with several types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controls device 222 in controlling the vehicle. In various embodiments, the vehicle controls device 222 implements machine learning techniques to assist the functionality of the vehicle controls device 222, such as feature detection/classification, obstruction mitigation, route traversal, mapping, sensor integration, ground-truth determination, and the like.

The output of vehicle controls device 222 is communicated to actuators 230. In an exemplary embodiment, the actuators 230 include a steering control, a shifter control, a throttle control, and a brake control. The steering control may, for example, control a steering system 216 as illustrated in FIG. 2. The shifter control may, for example, control a transmission 214 as illustrated in FIG. 2. The throttle control may, for example, control a propulsion system 213 as illustrated in FIG. 2. The brake control may, for example, control wheel brakes 217 as illustrated in FIG. 2.

Method

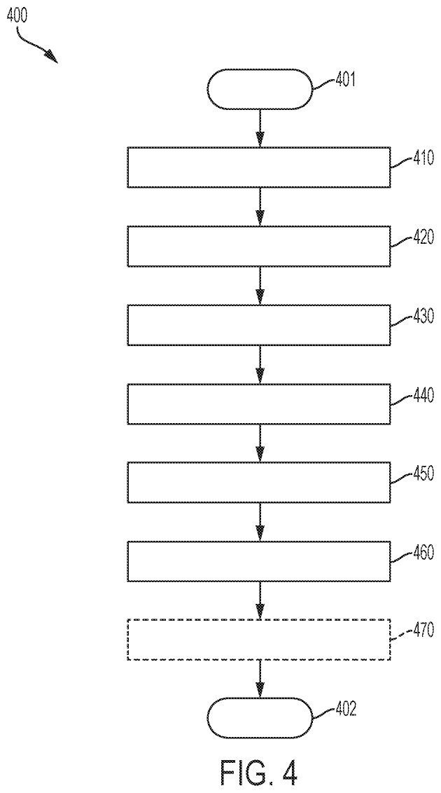

Turning now to FIG. 4, there is shown an embodiment of a method 400 to calculate a vehicle travel route based on the air quality between a starting location and a destination (i.e., an ideal travel route). In various embodiments, method 400 can moreover cause an autonomous version of vehicle 12 to autonomously travel from a first location (e.g., the starting location) to a second location (e.g., the destination) by traveling along this calculated ideal travel route. One or more aspects of notification method 400 may be completed through data center 18 which may include one or more executable instructions incorporated into databases 56 (memory) and carried out by server 54 (processor). One or more ancillary aspects of method 200 may also be completed by one or more vehicle devices such as, for example, GPS chipset/component 42 and telematics unit 24 as well as one or more vehicle sensors 72. One or more ancillary aspects of method 200 may further be completed by computer 15 which may be implementing AQI module 57. Skilled artisans will moreover see that telematics unit 24, data center 18, and computer 15 may be remotely located from each other.

Method 400 is supported by telematics unit 24 being configured to establish one or more communication protocols with data center 18. This configuration may be established by a vehicle manufacturer at or around the time of the telematics unit's assembly or after-market (e.g., via vehicle download using the afore-described communication system 10 or at a time of vehicle service, just to name a couple of examples). In at least one implementation, one or more instructions are provided to server 54 and stored on non-transitory computer-readable medium (e.g., database 56). In at least one implementation, one or more instructions are provided to the telematics unit 24 and stored on non-transitory computer-readable medium (e.g., electronic memory 40).

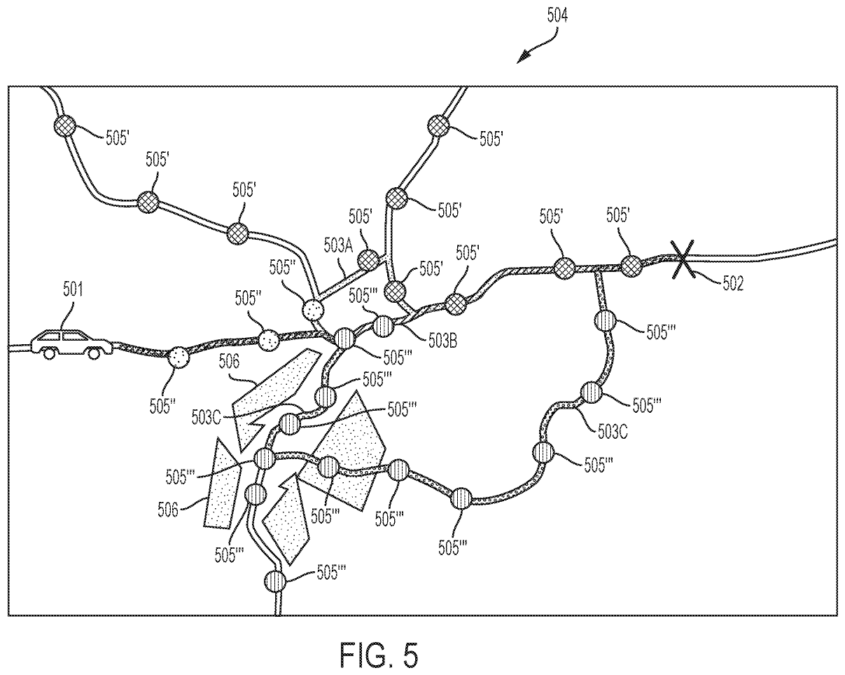

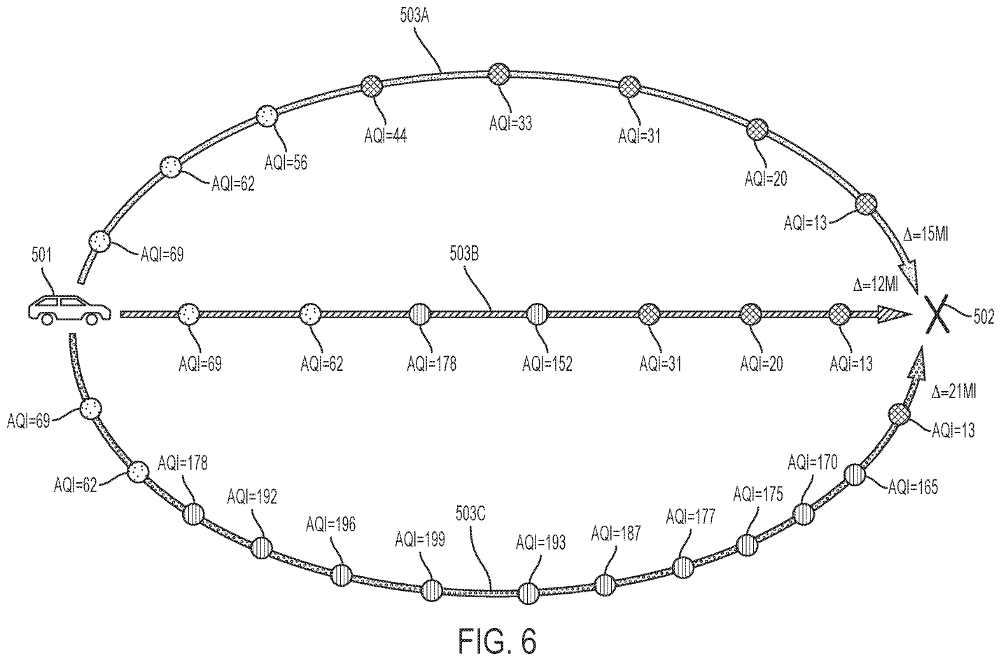

Method 400 begins at 401 in which vehicle 12 is in operation and at some location (i.e., a vehicle location/first location). In step 410, with additional reference to FIGS. 5 and 6, telematics unit 24 will correspond with GPS chipset/component 42 and transmit the current vehicle location 501 to server 54. In step 420, in one or more embodiments, a vehicle user will provide a desired destination 502 to telematics unit 24, for example, via a GUI user interface exhibited on the display of the infotainment unit. As such, the user will provide an address that corresponds to their desired destination into one or more virtual input fields of the user interface. Moreover, in this step, telematics unit 24 will transmit the desired destination 502 to server 54. In one or more alternative embodiments, the user will provide the desired destination 502 to telematics unit 24 through a known voice recognition system via microphone 30 (e.g., AMAZON ALEXA™, APPLE SIRI™, etc.). Thus, the user will speak the address of the destination into the microphone 30 and telematics unit 24 will either process the uttered speech or relay the speech to server 54 for processing. In an alternative embodiment, the user will provide the destination to a software app installed onto their smart phone (REMOTELINK by ONSTAR™, the MyChevy app, etc.) and the smart phone (not shown) will transmit the destination to telematics unit 24 and/or server 54.

In optional step 430, the user will provide an air quality preference to telematics unit 24 (e.g., via the GUI user interface on the infotainment display or via a voice recognition system) and telematics unit 24 will process the air quality preference or relay it to server 54. Alternatively, the user will provide the air quality preference to a software app installed onto their smart phone and the smart phone will transmit the air quality preference to telematics unit 24 and/or server 54. In addition, the air quality preference can be based on known EPA AQI guideline numbers and categories. As follows, when the user prefers an AQI of a “good” air quality (or when their health needs require such a quality), the user would provide an AQI value of somewhere between 0-50 or they could press a green colored virtual button on the infotainment display, provide to a voice recognition system that they want a “green” AQI or “good air quality” by speaking into microphone 30, or provide the information to their smart phone. Alternatively, when the user desires or their health needs require an AQI of a “moderate” air quality, the user would provide an AQI value of somewhere between 51-100 or they could press a yellow colored virtual button on the infotainment display, state that they want a “yellow” AQI or “moderate air quality” into the microphone 30, or provide such information to their smart phones.

In step 440, server 54 will implement one or more known navigational routing techniques to identify a number of different travel segments 503A-C (e.g., the Turn-by-Turn Navigation software package provided by ONSTAR™). As can be seen in the figures, these travel segments are mapped out travel routes between the vehicle location 501 and destination 502 and they may be laid out onto a virtual map 504. Moreover, each travel segment 503A-C may provide their own unique path of travel for vehicle 12 to go from the vehicle location 501 to destination 502 and thus the travel segments 503A-C can be of varying distances. For instance, travel segment 503A may represent an actual real-time travel route of 15 miles; whereas, travel segment 503B (which partially overlaps travel segments 503A and 503C) may represent an actual travel route of 12 miles and travel segment 503C may represent an actual travel route of 21 miles.

In step 450, in one embodiment, server 54 may collaborate with computer 15 and AQI module 57 to retrieve a number of the AQI markers 505, each of which represents the EPA's AQI of a specific geographic location/area on virtual map 504. For example, a “green” AQI marker 505′ would represent “good” air quality (i.e., an AQI value of somewhere between 0-50), whereas a “yellow” AQI marker 505″ would represent “moderate” air quality (i.e., an AQI value of somewhere between 51-100), and whereas a “red” AQI marker 505′″ would represent “unhealthy” air quality (i.e., an AQI value of somewhere between 151-200), and so on. In addition, in this step, server 54 will properly direct the AQI markers to the representative position on their corresponding travel segment. In essence, server 54 will correlate a travel marker of a certain geographic location with the travel path found to overlap at least a portion of that location. It should be understood that the AQIs discussed herein are exemplary and non-limiting as there can be more than three AQI categories and these additional categories may be associated with their own colors.

In step 450, in an alternative embodiment, server 54 will collaborate with databases 56 to retrieve real-time air quality markers 505 having been based on crowdsourcing techniques (i.e., air quality information derived from data provided by numerous connected vehicles). These air quality markers 505 can generally have the same characteristics as those that can be retrieved from AQI module 57. Therefore, a “green” AQI marker 505′ would represent “good” air quality (i.e., an AQI value of somewhere between 0-50), whereas a “yellow” AQI marker 505″ would represent “moderate” air quality (i.e., an AQI value of somewhere between 51-100), and whereas a “red” AQI marker 505′″ would represent “unhealthy” air quality (i.e., an AQI value of somewhere between 151-200), and so on. In addition, in this embodiment of step 450, server 54 will properly direct the AQI markers to the representative position on their corresponding travel segment.

In step 460, server 54 will calculate an ideal travel route by determining which travel segment has the best average air quality. As follows, server 54 will add all of the AQI marker numbers (i.e., an EPA guideline number associated with a marker) established along the entire length of the associated travel segment and divide that tallied number by the total number of travel markers along the travel segment. To illustrate, as can be seen in FIG. 6, travel segment 503A includes eight (8) unique travel markers with the following EPA guideline numbers (in order from vehicle location 501 to destination 502)—69, 62, 56, 44, 33, 31, 20, and 13—and thus the average air quality for this segment would be 328/8=41, which constitutes an average air quality of “good” (or categorized as green). On the other hand, travel segment 503B includes seven (7) unique travel markers with the following numbers (in order from vehicle location 501 to destination 502)—69, 62, 178, 152, 31, 20, and 13—and thus the average air quality for this segment is 525/7=75, which constitutes an average air quality of “moderate” (or categorized as yellow). Lastly, travel segment 503C includes eleven (11) unique travel markers with the following numbers (in order from vehicle location 501 to destination 502)—69, 62, 178, 192, 196, 199 193, 187, 177, 175, 170, 165, and 13—and thus the average air quality for this segment is 1976/13=152, which constitutes an average air quality of “unhealthy” (or categorized as red). It should be understood that travel segment 503C may have been categorized red and deemed an unhealthy travel route because the travel segment 503C goes through areas of industry 506, having been known to be heavily polluted.

In addition, in this step, server 54 will compare and contrast the average air qualities for each travel segment (as shown above, for example, 503A=41, 503B=75, and 503C=152) and the server 54 is generally defaulted to choose the travel segment with the lowest average air quality as the ideal travel route (which would be travel segment 503A in the above example). However, when the user has provided an air quality preference (optional step 430), server 54 will choose the travel segment with an air quality that best corresponds to the user's preferred air quality as the ideal travel route. As follows, if the user prefers an air quality of “good” (green), then server 54 would choose travel segment 503A as the ideal travel route because the segment has an average air quality number of 41. Alternatively, if for some reason the user prefers an air quality of “moderate” (yellow), in one or more embodiments, server 54 would choose travel segment 503B as the ideal travel route because this segment has an average air quality of 75. In one or more other embodiments, server 54 may consider the user preferred air quality of “moderate” as a base line and then rule out any travel segments with a less than moderate average air quality (e.g., travel segment 503C would be removed as an option). Thus, in these embodiments, sever 54 would be left to choose an ideal travel route between the options of 503A (avg. AQI=41) and 503B (avg. AQI=75) because each of these segments falls below an AQI=100 (the highest AQI number considered to be “moderate” by the EPA). As follows, server 54 would choose travel segment 503A as the ideal travel route because the segment has the lower average AQI number of the two route options. Skilled artist will see that server 54 generally does not take the distance of the travel segment 503 into account when calculating an ideal travel route. However, it should be understood that server 54 may take distance into account when comparing one or more travel segments whose travel segments are greatly uneven (e.g., travel segment 503A=75 miles in length; whereas, travel segment 503B=8 miles in length). In such instances, server 54 may choose a shorter travel length because the convenience of a short trip greatly outweighs the health concerns or pleasantries associated with the trip's air quality.

In optional step 470, in one or more embodiments, server 54 will generate executable instructions that can be read by at least telematics unit 24 and executed by at least vehicle controls device 222 of an autonomous version of vehicle 12. Moreover, upon being read and executed by vehicle 12, the instructions will cause the vehicle 12 to travel from the vehicle location 501 to the destination 502 along the chosen ideal travel route (e.g., 503A of the above example). Moreover, in this step, server 54 will transmit these software instructions to telematics unit 24 and thus, when executed by vehicle controls device 222, vehicle 12 will traverse from the vehicle location 501 to the destination 502 along the chosen ideal travel route.

In optional step 470, in one or more alternative embodiments, server 54 will generate executable instructions that can be read by at least telematics unit 24. Moreover, upon being read and executed by telematics unit 24, these software instructions will cause the telematics unit 24 to generate a GUI user interface exhibited on the display of the infotainment unit. This user interface will provide travel directions that will have them arrive at the destination 502 by taking the chosen ideal travel route. As such, the user will be prompted to operate their vehicle so as to drive it from the vehicle location 501 to the destination 502 along the ideal travel route. Moreover, this these travel directions may be displayed using one or more known software modules (e.g., turn-by-turn navigation from ONSTAR™). After step 470, method 400 will move to completion 502.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the system and/or method that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for” in the claim.

What is claimed is:

1. A method of calculating an ideal travel route based on air quality, the method comprising:
receiving, at a processor, a vehicle location;
receiving, at the processor, a destination;
identifying, via the processor, a plurality of travel segments based on the vehicle location and destination;
receiving, via the processor, one or more air quality index (AQI) markers associated with each travel segment; and
calculating, via the processor, the ideal travel route based on the one or more AQI markers associated with each travel segment.

2. The method of claim 1, further comprising:
wherein the vehicle is an autonomous vehicle;
generating, via the processor, one or more executable instructions configured to cause the vehicle to autonomously travel from the vehicle location to the destination along the ideal travel route; and
transmitting, via the processor, the one or more executable instructions to the vehicle.

3. The method of claim 2, further comprising:
receiving, at the vehicle, the one or more executable instructions; and
executing, via the vehicle, the executable instructions so as to autonomously travel from the vehicle location to the destination along the ideal travel route.

4. The method of claim 1, further comprising:
producing, via the processor, one or more executable instructions configured to generate a user interface to prompt a user to operate the vehicle to travel from the vehicle location to the destination along the ideal travel route, wherein the user interface can be displayed on a display of the vehicle; and
transmitting, via the processor, the one or more executable instructions to the vehicle.

5. The method of claim 1, further comprising:
receiving, via the processor, an air quality preference from the vehicle; and
wherein the ideal travel route is additionally based on the air quality preference.

6. The method of claim 1, wherein the one or more AQI markers are retrieved from an AQI module remotely located in a computer.

7. The method of claim 1, wherein the one or more AQI markers are based on air quality data provided from numerous vehicles in wireless communication with the processor.

8. A system to calculate an ideal travel route based on air quality, the system comprising:
a memory configured to comprise one or more executable instructions and a processor configured to execute the executable instructions, wherein the executable instructions enable the processor to carry out the following steps:
receiving a vehicle location from a vehicle;
receiving a destination from the vehicle;
identifying a plurality of travel segments based on the vehicle location and destination;
receiving one or more air quality index (AQI) markers associated with each travel segment; and
calculating the ideal travel route based on the one or more AQI markers associated with each travel segment.

9. The system of claim 8, further comprising:
wherein the vehicle is an autonomous vehicle;
the executable instructions enable the processor to carryout the following steps:
generating one or more software instructions configured to cause the vehicle to autonomously travel from the vehicle location to the destination along the ideal travel route; and
transmitting the one or more software instructions to the vehicle.

10. The system of claim 9, further comprising:
receiving, at the vehicle, the one or more software instructions; and
executing, via the vehicle, the software instructions so as to autonomously travel from the vehicle location to the destination along the ideal travel route.

11. The system of claim 8, further comprising:
producing one or more software instructions configured to generate a user interface to prompt a user to operate the vehicle to travel from the vehicle location to the destination along the ideal travel route, wherein the user interface can be displayed on a display of the vehicle; and
transmitting the one or more software instructions to the vehicle.

12. The system of claim 8, further comprising:
wherein the executable instructions enable the processor to carryout the step of receiving an air quality preference from the vehicle; and
wherein the ideal travel route is additionally based on the air quality preference.

13. The system of claim 8, wherein the one or more AQI markers are retrieved from an AQI module remotely located in a computer.

14. The system of claim 8, wherein the one or more AQI markers are based on air quality data provided from numerous vehicles in wireless communication with the processor.

15. A non-transitory and machine-readable medium having stored thereon executable instructions adapted to calculate an ideal travel route based on air quality, which when provided to a processor and executed thereby, causes the processor to carry out the following steps:
receiving a vehicle location from a vehicle;
receiving a destination from the vehicle;
identifying a plurality of travel segments based on the vehicle location and destination;
receiving one or more air quality index (AQI) markers associated with each travel segment; and
calculating the ideal travel route based on the one or more AQI markers associated with each travel segment.

16. The non-transitory and machine-readable memory of claim 15, further comprising:
wherein the vehicle is an autonomous vehicle;
the executable instructions enable the processor to carryout the following steps:
generating one or more software instructions configured to cause the vehicle to autonomously travel from the vehicle location to the destination along the ideal travel route; and
transmitting the one or more software instructions to the vehicle.

17. The non-transitory and machine-readable memory of claim 16, further comprising:
receiving, at the vehicle, the one or more software instructions; and
executing, via the vehicle, the software instructions so as to autonomously travel from the vehicle location to the destination along the ideal travel route.

18. The non-transitory and machine-readable memory of claim 15, further comprising:
producing one or more software instructions configured to generate a user interface to prompt a user to operate the vehicle to travel from the vehicle location to the destination along the ideal travel route, wherein the user interface can be displayed on a display of the vehicle; and
transmitting, via the processor, the one or more executable instructions to the vehicle.

19. The non-transitory and machine-readable memory of claim 15, further comprising:
wherein the executable instructions enable the processor to carryout the step of receiving an air quality preference from the vehicle; and
wherein the ideal travel route is additionally based on the air quality preference.

20. The non-transitory and machine-readable memory of claim 15, wherein the one or more AQI markers are retrieved from an AQI module remotely located in a computer.
